(19) United States
(12) Patent Application Publication
(10) Pub. No.: US 2026/0086811 A1
(43) Pub. Date: Mar. 26, 2026

(54) OUT-OF-ORDER EXECUTION IN MULTI-CHIPLET PROCESSORS

(71) Applicant: ADVANCED MICRO DEVICES, INC., Santa Clara, CA (US)

(72) Inventors: Mark Unruh Wyse, Bellevue, WA (US); Joseph L. Greathouse, Austin, TX (US); Anthony Thomas Gutierrez, Seattle, WA (US); Ali Arda Eker, Bellevue, WA (US)

(21) Appl. No.: 18/897,392

(22) Filed: Sep. 26, 2024

(51) Int. Cl. G06F 9/38

(52) U.S. Cl. CPC G06F 9/3838; G06F 9/3856

(57) ABSTRACT

Systems and techniques for providing out-of-order execution in multi-chiplet processors utilize dependency information stored in a task queue to maximize parallelization and optimize throughput of task execution in parallel processors. A command processor is configured to receive dependency information from the task queue specifying one or more dependencies for one or more tasks in the queue. In some implementations, the dependency information specifies one or more tasks and dependencies for the specified one or more tasks. In some implementations, the dependency information specifies a completion signal indicating whether the dependencies have been satisfied. Based on the dependency information and the completion signals, the command processor parses the task queue to readily identify tasks that are ready for execution independently from the order of the tasks in the queue.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing out-of-order execution in a multi-chiplet processor according to some implementations.

FIG. 2 is a block diagram illustrating an example of out-of-order execution in a multi-chiplet processor according to some implementations.

FIG. 3 is a block diagram illustrating an example of dependency information according to some implementations.

FIG. 4 is a flow diagram illustrating an example of out-of-order execution in a multi-chiplet processor according to some implementations.

FIG. 5 is a flow diagram of a method of executing tasks out of order in multi-chiplet processors according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor (CP) coupled to the plurality of shader engines. The CP receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface, which acts as a scheduler, associated with the respective shader engine.

As GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of parallel processing chiplets (PPCs), which are configured to process tasks and function as advanced GPU chiplets in that they offer one or more of parallel processing functionality, optimized GPU functionality, and optimized processing for advanced applications that utilize, e.g., reduced precision data common in machine learning. The PPCs are able to execute instructions separately or in parallel and, in some implementations, share a single pool of virtual and physical memory with extremely low latency. However, conventional PPCs often execute tasks in order with only primitive means for taking dependencies into account. For example, blocking information associated with one or more tasks may indicate that no further tasks can be processed until the tasks associated with the blocking bits finish executing. However, such unyielding blocking techniques prevent the PPCs from flexibly performing out-of-order execution and thus significantly limit parallelization and throughput of task execution in the PPCs.

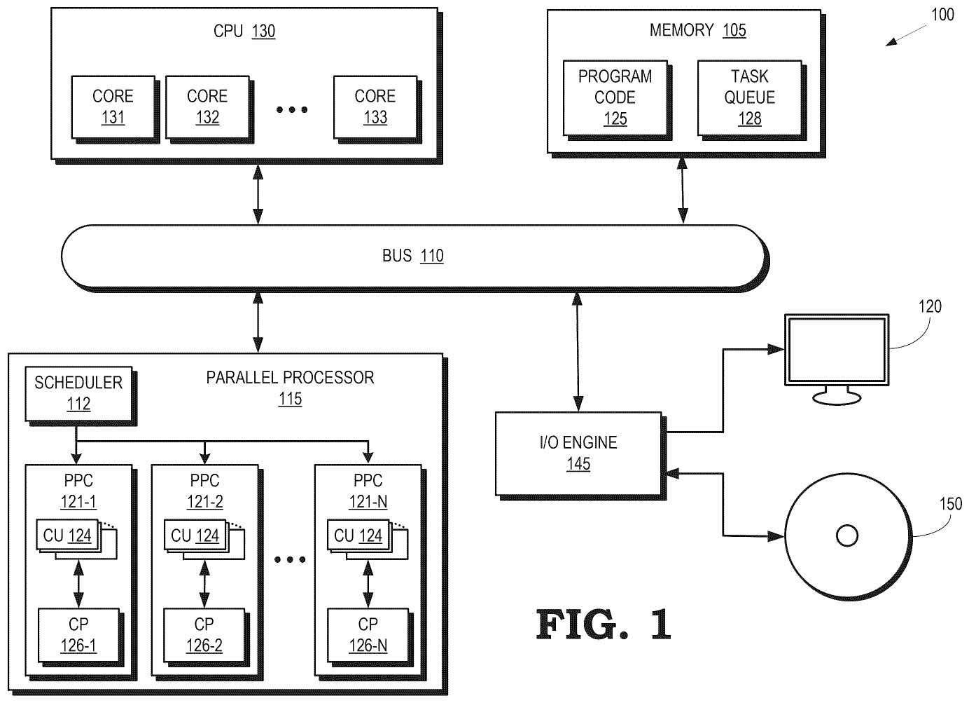

FIGS. 1-5 illustrate systems and techniques for providing out-of-order execution in multi-chiplet processors. In general, packet processing flow in multi-chiplet processors is a process through which instruction packets (i.e., bundles of instructions) are processed within a processor pipeline. In order to provide out-of-order execution, in some implementations, the packet processing flow and related processes are designed to select and execute packets out of order. For example, packet dependency resolution is a process of determining and resolving dependencies between instructions within a packet, ensuring they can be executed in the correct order without conflicts. Packet launch initiates instruction execution where the processor dispatches a packet of instructions to appropriate execution units, while a packet processing state indicates the current status of a packet within the processor pipeline, tracking its progress through various stages of execution, e.g., from fetch to retire. In some implementations, as described in detail hereinbelow, packet processing flow is enhanced to separate packet dependency resolution from packet launch. Techniques for recording packet processing state are provided, thereby enabling out-of-order packet dispatch. Dependency packets enable explicit conveyance of task dependencies in queue-based execution models, replacing most uses of unyielding blocking information. Software-and hardware-based dependency tracking mechanisms support task dependency resolution, and scheduling algorithms for task selection improve dispatch throughput.

FIG. 1 is a block diagram of a processing system 100 providing out-of-order execution in a multi-chiplet processor according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as parallel processor 115, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of PPCs, such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In some implementations, as shown in the example of FIG. 1, the PPCs 121 each include a CP 126, such as CPs 126-1, 126-2, and 126-N, to manage and facilitate execution of incoming instructions or tasks in order to provide out-of-order execution in the PPCs 121. Tasks are stored in a task queue 128 in the memory 105, which also stores dependency information related to the tasks. In some implementations, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some implementations, the task queue 128 is implemented as a circular buffer with associated read and write pointers, but in other implementations the task queue 128 takes other forms such as an ordered list or cache.

In order to facilitate out-of-order execution in the PPCs 121, The CP 126 receives or retrieves dependency information and tasks, which may reference or link to program code 125 in the memory 105, from the task queue 128. Based on the dependency information, the CP 126 assigns the compute units 124 with tasks that do not have any associated dependency information or tasks for which any associated dependency information has been satisfied, i.e., the dependencies have been resolved. Thus, the CP 126 is able to parse through the task queue 128 to selectively assign tasks for execution to the compute units 124 as the tasks become available for execution, enabling out-of-order execution of the tasks in the task queue 128.

As shown in FIG. 1, the parallel processor 115 further includes a scheduler 112, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some implementations, the scheduler 112 and the command processors 126 work together or in parallel to process tasks and dependency information from the task queue 128. For example, in some implementations, the scheduler 112 assigns tasks to the compute units 124, and the compute units 124 interface with the task queue 128 to determine when tasks can be executed out of order based on dependency information specified in the task queue 128. In some implementations, the scheduler 112 interfaces with the task queue 128 to determine which tasks to assign to the compute units 124 based on the dependency information. Accordingly, in some implementations, the scheduler 112 and compute units 124 work together to ensure maximum parallelization and optimized throughput of task execution in the parallel processor 115.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

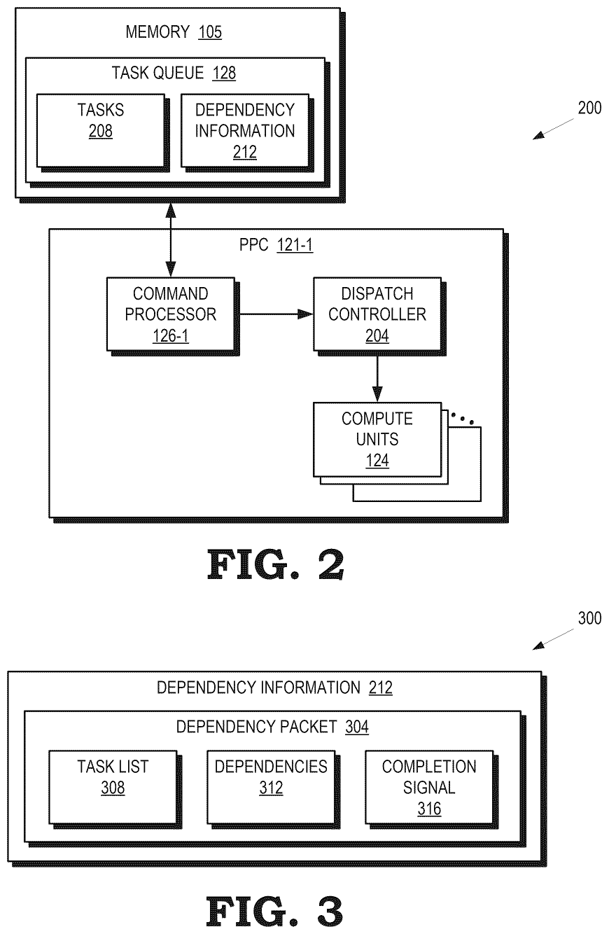

FIG. 2 is a block diagram 200 illustrating an example of out-of-order execution in a multi-chiplet processor according to some implementations. As shown in FIG. 2, the PPC 121-1 includes a command processor 126-1, a dispatch controller 204, and compute units 124. As noted above, the CP 126-1 manages and facilitates execution of incoming instructions or tasks in order to provide out-of-order execution in the PPC 121-1. When the CP 126-1 identifies tasks that are ready for execution (e.g., tasks that do not have associated dependency information or for which any associated dependency information has been satisfied), the CP 126-1 assigns the tasks to the dispatch controller 204, which selects one or more compute units 124 to execute the tasks.

As shown in FIG. 2, the task queue 128 specifies one or more tasks 208 and dependency information 212 associated with or related to the tasks 208. For example, in some implementations, the dependency information 212 specifies which of the tasks 208 need to finish execution before other ones of the tasks 208 can be dispatched and executed. In some implementations, the dependency information 212 is generated by a compiler during compilation of the tasks 208 when the compiler identifies variables or other values that depend on the results of executing other tasks.

For example, a first task may calculate a set of vertices, a second task may apply textures based on the vertices, and a third task may apply shading to the textures. In this example, the third task requires the second task to be completed before it can begin execution, and the second task requires the first task to be completed before it can begin execution. Therefore, in this example, the dependency information 212 specifies that the third task depends on the second task and the second task depends on the first task, ensuring that these tasks are completed in order. However, a fourth task may be inserted in the task queue 128 between the first task and the second task that does not depend on any of the other tasks. For example, the fourth task may calculate an unrelated set of vertices. As the dependency information 212 will either specify that the fourth task has no dependencies or will contain no information about the fourth task, indirectly indicating that it has no dependencies, the command processor 126-1 can select the fourth task for execution and provide it to the dispatch controller 204 prior to the first task finishing executing. In this way, the command processor 126-1 is able to select tasks 208 for execution based on the dependency information 212 in an order different from the order of the tasks 208 specified in the task queue 128, facilitating out-of-order execution and thus maximizing parallelization and optimized throughput of task execution in the parallel processor 115.

FIG. 3 is a block diagram 300 illustrating an example of dependency information such as the dependency information 212 of FIG. 2 according to some implementations. As shown in FIG. 3, in some implementations, the dependency information 212 is specified in one or more dependency packets 304. The dependency information 212 includes one or more task lists 308, dependencies 312, and completion signals 316. Generally, the task list 308 specifies one or more tasks, such as one or more of the tasks 208 of FIG. 2, which either have a dependency or are part of another task's dependency information. The dependencies 312 in the dependency packet 304 specify the relationship of the tasks in the task list 308.

For example, continuing with the above example of four tasks, the dependencies 312 would specify that the third task depends on the second task and the second task depends on the first task, ensuring that these tasks are completed in order. In order to indicate that the fourth task does not depend on any of the first, second, or third tasks, the dependencies 312 in the dependency packet 304 either explicitly indicate that the fourth task has no dependencies or does not include the fourth task in the task list 308, thus indirectly indicating that the fourth task has no dependencies. In some implementations, the dependency information 212 includes a dependency packet 304 that provides an indication of a second dependency packet specifying further dependencies for, e.g., one or more tasks specified in the dependency packet 304. That is, in some implementations, multiple dependency packets 304 can be linked such that, in effect, one dependency packet 304 depends on another dependency packet 304.

The completion signal 316 in the dependency packet 304 directly or indirectly indicates whether one or more of the dependencies 312 are satisfied. For example, in some implementations, the completion signal 316 stores a value or a pointer to a value (e.g., in the memory 105 of FIG. 1) that indicates whether the dependencies 312 for an associated task list 308 have been satisfied. In some implementations, the value indicates a number of dependencies such that, as each dependency is satisfied, the value is decremented such that when the value reaches zero all of the dependencies for the task list 308 are satisfied. In some implementations, the completion signal 316 and/or dependencies 312 indicate an AND or OR condition such that either all of the tasks in the task list 308 or at least one of the tasks in the task list 308 must finish execution before the dependencies 312 are considered satisfied. By using a completion signal 316 linked to a value that clearly indicates whether the dependencies 312 for a task list 308 in a dependency packet 304 have been satisfied, the command processors 126 of FIG. 1 are able to quickly parse through the dependency information 212 to identify tasks that are ready for execution.

Generally, the dependency packet 304 specifies any one or more of the task list 308, the dependencies, and the completion signal 316. For example, as noted above, in some implementations, the dependency information 212 includes a dependency packet 304 that provide an indication of a second dependency packet specifying further dependencies for, e.g., one or more tasks specified in the dependency packet 304. Thus, depending on the limitations (e.g., number of bits) of the dependency packet, a first dependency packet may only list a number of tasks in the task list 308 and/or a number of dependencies 312 with no corresponding completion signal 316. A second dependency packet may then specify further tasks and/or dependencies, including a dependency indicating or referring to the first dependency packet, along with a completion signal 316. By enabling dependency packets 304 to be linked to one another, complex and varied dependencies of various tasks are able to be specified without limitation even when each dependency packet 304 may only include a limited number of bits or data fields.

Dependency packets enable flexible and arbitrary specification of M:N dependency relationships. For example, a dependency packet may indicate that all M tasks require any or all of N dependencies to be complete. In some implementations, the command processor uses dependency packets to record inter-task dependencies in one or more dependency tracking mechanisms, such as a scoreboard or dependency chart. In some implementations, these dependency packets act as control directives that cannot be ignored by the command processor.

In some implementations, the dependency packet requires at least one dependency and one task associated with the dependency to be specified. However, more than one of each (dependency or associated task) may be specified. In this case, the dependency packet is used to convey explicit dependency information to the command processor. If the command processor is tracking dependency information in an internal state, the dependency packet itself can be immediately completed and retired after recording the dependency relationships.

In some cases, all the dependency fields are dependency signals. In this case, the packet itself completes execution and can be retired, which includes setting the packet's completion signal (e.g., to zero or decrementing by one), when an AND or OR condition of the dependency signal is complete, depending on the requirements of the completion signal. This effectively provides a packet with non-blocking barrier semantics. In some implementations, the command processor implements dependency tracking, such as a scoreboard, e.g., in software, with dependency tracking data structures stored in memory, such as the memory 105 of FIG. 1. Generally, the memory is a dedicated memory or part of a global address space that may be cached locally to improve access performance. Software dependency tracking allows the command processor to flexibly implement the dependency tracking algorithm.

In some implementations, a hardware scoreboard is used to record all dependencies of a specific task. Each entry in the scoreboard maps a task to a set of dependencies. In some implementations, as dependency completions are observed, the scoreboard is updated to remove the satisfied dependencies from the set of outstanding dependencies for all tasks in the scoreboard associated with that dependency. In this way, the command processor is able to quickly scan the scoreboard to identify tasks with no outstanding dependencies, indicating they are ready for dispatch. In some implementations, the scoreboard supports a maximum number of dependencies per recorded task (e.g., up to X dependencies per task) or applies a combined hardware/software approach that tracks up to Y dependencies in the hardware scoreboard and defers to software management if a task has more than Y dependencies. In some implementations, the value of Y is selected based on expected dependency counts of tasks found in common applications and programming models.

In some implementations, when using a scoreboard mechanism, bits in the task packets, e.g., a barrier bit or a bit in the packet header, records whether all of a packet's dependencies have been resolved. A value of zero can indicate the packet's dependencies are resolved, while a value of one or more can indicate the packet has unresolved dependencies. The command processor quickly examines this bit as it considers packets for dispatch, bypassing packets with a bit value of one or more.

In some implementations, an offset field of a task or dependency packet specifies a size of an atomic set of N tasks that rely on a dependency packet's recorded dependencies. If the offset is non-zero, the next N packets are members of the atomic set. When the command processor is traversing the queue looking for out-of-order scheduling opportunities, when it finds a packet with barrier bit set to 1 and the offset field is non-zero, the command processor will add this offset to the current packet's ID in the task queue and the read pointer to identify the next packet or set of packets to analyze as being ready for execution, e.g., packets having satisfied dependencies.

In some implementations, dependency packets are provided to the command processor through a secondary queue associated with the primary task queue. This secondary queue operates independently of the primary task queue, optionally including being fetched by dedicated prefetchers, to provide the command processor with dependency information that are recorded in the dependencies being processed in advance of the primary task queues. This enables the command processor to pre-populate the dependency tracking state (e.g., scoreboards).

In some implementations, multiple dependency packets are aggregated into a single dependency packet to reduce a number of dependency packets in the task queue or the secondary dependency packet queue. In some implementations, the granularity of dependencies enforced is adjusted, for example creating a dependency relationship that applies to an entire group of task packets, to take advantage of tradeoffs in dependency tracking and task execution concurrency or effort.

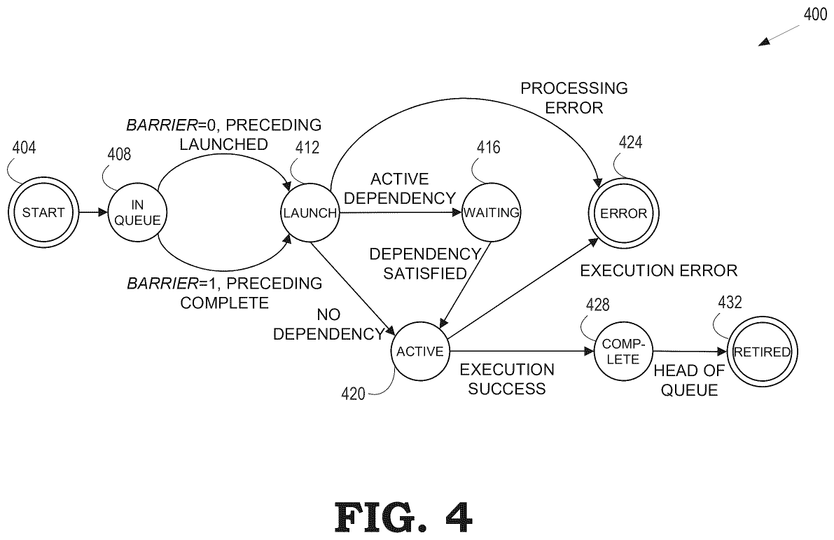

FIG. 4 is a flow diagram 400 illustrating an example of out-of-order execution in a multi-chiplet processor according to some implementations. FIG. 4 shows example states that a packet specifying a task or dependency packet encounters as it is processed and executed by the compute units 124. When a packet is requested from a task queue such as the task queue 128 of FIG. 1 by the command processor, the packet is first associated with a start state 404, and then the packet is marked with an in-queue state 408 after the command processor receives the packet. The in-queue state 408 indicates that the command processor has not yet started to parse the packet. After any barriers to launch, such as any barrier bits that prevent subsequent packets from being launched until preceding packets are launched or complete, are cleared or satisfied, the packet is marked with a launch state 412, indicating that the packet is being parsed but has not yet started execution.

After a packet is assigned the launch state 412, in some implementations, it is not immediately executed. Instead, the command processor checks dependency information, such as the dependency information 212 of FIG. 3, for the packet to ensure that any dependencies have been satisfied, e.g., that any completion signals or associated values indicate that any dependencies associated with the packet have been satisfied. If the dependency information has not yet been satisfied, the packet is assigned a waiting state 416 until the dependencies are satisfied. Once all dependencies have been satisfied, or if there are no dependencies associated with the packet, the packet or task is ready for execution and is assigned an active state 420, after which time the command processor assigns the packet or task to compute units for execution. If any error occurs while a packet is in the launch state 412 or the active state 420, the packet will be assigned to an error state 424, after which the command processor will trigger an interrupt or otherwise indicate to an associated PPC or CPU that the packet or task has failed to launch or execute.

After execution of the packet is successfully completed, the command processor marks the packet with a complete state 428 and, once the packet reaches the front or head of the task queue, the command processor marks the packet with a retired state 432. In some implementations, after a packet is marked with the retired state 432, any completion signals such as the completion signal 316 of FIG. 3 or related values associated with the packet are modified, e.g., decremented, to indicate that any dependencies that require the current packet to finish executing have been satisfied.

In some implementations, the packet state is encoded using available bits in a header of the dependency packet 304. A valid packet remains encoded by a packet type other than “invalid” while a retired packet has its type set to “invalid” to indicate the packet slot in the queue is available for a new packet. In some implementations, the packet state is encoded directly in a packet type field of the packet header, with packet types configured to encode different packet states such as waiting, active, and complete.

In some implementations, the semantics of packet processing in this model require the task queue's read pointer to only be advanced past packets that have reached the complete state. This is performed as part of packet retirement. In some implementations, multiple complete packets are retired as a group by marking each packet's state as invalid and advancing the read pointer by the number of packets in the group if all the packets are complete.

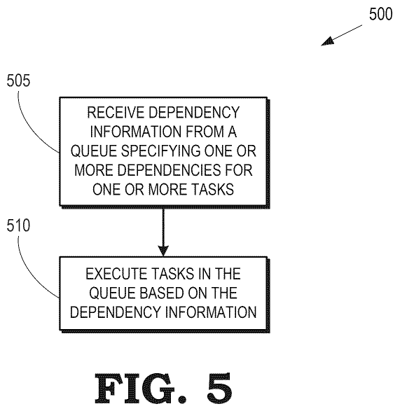

FIG. 5 is a flow diagram of a method 500 of executing tasks out of order in multi-chiplet processors, such as the parallel processor 115 of FIG. 1 including a plurality of PPCs 121, to provide out-of-order execution according to some implementations. In some implementations, the method 500 is executed by one or more command processors, dispatch controllers, and compute units, such as one or more of the command processors 126 and compute units 124 of FIG. 1 and the dispatch controller 204 of FIG. 2. At block 505 of the method 500, the command processor receives dependency information from a task queue, the dependency information specifying one or more dependencies for one or more tasks. At block 510, the command processor, dispatch controller, and/or compute units execute tasks in the task queue based on the dependency information.

In some implementations, the tasks are arranged in the task queue in a first order, the method further comprising executing the tasks in a second order different from the first order based on the dependency information. In some implementations, the method 500 further includes storing dependency information in the task queue in a dependency packet. In some implementations, the method 500 further includes specifying one or more tasks and one or more dependencies for the specified one or more tasks in the dependency packet. In some implementations, the method 500 further includes specifying a completion signal indicating a status of the one or more dependencies in the dependency packet. In some implementations, the method 500 further includes modifying a value associated with the completion signal when a dependency is satisfied. In some implementations, the method 500 further includes storing an indication of a second dependency packet specifying further dependencies for the one or more tasks in the dependency packet. In some implementations, the method 500 further includes assigning a task to a waiting state prior to executing the task when dependencies associated with the task are active and waiting to be satisfied.

In some implementations, the apparatuses and techniques described above are implemented in a system including one or more integrated circuit (IC) devices (also referred to as integrated circuit packages or microchips), such as the parallel processor 115, the PPCs 121, the scheduler 112, the compute units 124, the command processors 126, and the method 500 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a multi-chiplet processor comprising:
a plurality of parallel processing chiplets (PPCs) configured to process tasks, each of the PPCs including a command processor,
wherein the command processor is configured to receive dependency information from a task queue, the dependency information specifying one or more dependencies for one or more of the tasks.

2. The apparatus of claim 1, wherein the dependency information specifies one or more tasks and one or more dependencies for the specified one or more tasks.

3. The apparatus of claim 2, wherein the dependency information specifies a completion signal indicating a status of the one or more dependencies.

4. The apparatus of claim 3, wherein the completion signal indicates whether the one or more dependencies are satisfied.

5. The apparatus of claim 4, wherein the one or more dependencies are satisfied when one or more tasks specified by the dependency information are finished executing.

6. The apparatus of claim 3, wherein the completion signal indicates a number of dependencies.

7. The apparatus of claim 6, wherein the completion signal is associated with a value that is modified when a dependency is satisfied.

8. The apparatus of claim 1, wherein the command processor is configured identify one or more tasks in the task queue that are ready for execution based on the one or more dependencies.

9. The apparatus of claim 1, wherein the dependency information is stored in the task queue in a dependency packet.

10. A method, comprising:
receiving dependency information from a task queue, the dependency information specifying one or more dependencies for one or more tasks; and
executing tasks in the task queue based on the dependency information.

11. The method of claim 10, wherein the tasks are arranged in the task queue in a first order, the method further comprising executing the tasks in a second order different from the first order based on the dependency information.

12. The method of claim 10, further comprising storing dependency information in the task queue in a dependency packet.

13. The method of claim 12, further comprising specifying one or more tasks and one or more dependencies for the specified one or more tasks in the dependency packet.

14. The method of claim 13, further comprising specifying a completion signal indicating a status of the one or more dependencies in the dependency packet.

15. The method of claim 14, further comprising modifying a value associated with the completion signal when a dependency is satisfied.

16. The method of claim 12, further comprising storing an indication of a second dependency packet specifying further dependencies for the one or more tasks in the dependency packet.

17. The method of claim 10, further comprising assigning a task to a waiting state prior to executing the task when dependencies associated with the task are active and waiting to be satisfied.

18. A system comprising:
a memory configured to store a task queue specifying tasks and dependency information for the tasks; and
a multi-chiplet processor comprising:
a plurality of parallel processing chiplets (PPCs) configured to process tasks, each of the PPCs including a command processor,
wherein the command processor is configured to retrieve the tasks and dependency information for the tasks from the task queue and to execute the tasks in a first order based on the dependency information.

19. The system of claim 18, wherein the task queue stores tasks in a second order different from the first order.

20. The system of claim 18, wherein the task queue stores the dependency information in dependency packets that specify one or more tasks and one or more dependencies for the tasks.
